(19) United States
(12) Patent Application Publication
(10) Pub. No.: US 2026/0141822 A1
(43) Pub. Date: May 21, 2026

(54) TAB COLORS NOTATION SYSTEM

(71) Applicant: Francis L. Hickey, Watertown, MA (US)

(72) Inventor: Francis L. Hickey, Watertown, MA (US)

(21) Appl. No.: 19/388,406

(22) Filed: Nov. 13, 2025

Related U.S. Application Data
(60) Provisional application No. 63/720,873, filed on Nov. 15, 2024.

(51) Int. Cl. G09B 15/02; G10G 1/00

(52) U.S. Cl. CPC G09B 15/02; G10G 1/00

(57) ABSTRACT

A music notation system for string instruments features a time signature indicator and measure sections with representations arranged in a single horizontal plane to eliminate spatial recognition requirements and avoid navigation across multiple information planes. Each representation includes colored numbers denoting fret positions and string colors, spatially arranged to eliminate the need for musicians to leap across different vertical positions when reading sequential notes. Graphical indicators positioned separately from and in proximity to the colored numbers specify note duration, with visual separation isolating rhythmic components from note identification. This reduces visual processing complexity, providing a method for string instrument players to interpret and perform musical compositions accurately without requiring spatial recognition skills.

### CROSS-REFERENCE TO RELATED APPLICATION(S)

This application claims priority to, and the benefit of, co-pending U.S. Provisional Application 63/720,873, filed Nov. 15, 2024, for all subject matter common to both applications. The disclosure of said provisional application is hereby incorporated by reference in its entirety.

### FIELD OF THE INVENTION

The present invention relates to a music notation system suitable for stringed instruments. In particular, the present invention relates to a system of music notation that does not require musicians to utilize their spatial recognition skills or force them to navigate multiple planes of information on a page.

### BACKGROUND

Generally, conventional notation systems feature layouts that require the reader to leap across several planes of information. In other words, a musician may have to read one note at the bottom of a music staff only to jump to the very top of the staff to read the very next note when reading a passage written in standard notation. This is also true of tablature notation, a common system for writing music for fretted string instruments, such as the guitar, bass guitar, and ukulele. Rhythmic notation also presents its own challenges, as readers are expected to decode arbitrary symbols such as note stems, flags, dots next to note heads, and other iconography that is attached to the note itself. This practice compacts a great deal of information into a very small amount of space, and can present challenges for musicians with and without disabilities.

Previous attempts to address these issues have included various color-coded notation systems and simplified tablature approaches. For example, existing systems have used colored strings coordinated with colored notation, numbered systems for notes and octaves, and visual displays for guitar fretboards with colored symbols. However, these prior approaches still suffer from fundamental limitations. Color-coded string systems still require musicians to navigate multiple spatial planes when reading sequential notes, as the color coding merely replaces one form of spatial recognition with another. Simplified notation systems using numbers or geometric shapes for notes continue to present information in cluttered layouts that compact rhythmic, pitch, and fingering information into single symbols or closely grouped elements. Educational guitar notation systems, while providing visual fretboard displays, still require spatial processing skills to correlate symbols across different areas of the display and often present information in multiple planes simultaneously. These conventional approaches experience the following shortcomings: placing a great deal of emphasis on the reader's visual processing skills, presenting information in a monochrome format or in spatially complex arrangements, presenting more information than is necessary in compact spaces, and displaying information in a very cluttered and hard to read layout that requires navigation across multiple information planes.

### SUMMARY

There is a need for a system of music notation that does not require musicians to utilize their spatial recognition skills or force them to navigate multiple planes of information on a page. This is a particular area of need for musicians with physical disabilities or learning disabilities that impedes their ability to access standard music notation. The present invention is directed toward further solutions to address this need by providing a unique single-plane arrangement of colored numbers representing fret positions and strings, with rhythmic information visually separated from note identification. Unlike existing color-coded notation systems that still require spatial navigation across multiple planes, or simplified notation systems that compact multiple types of information into single symbols, the present invention eliminates the need for spatial recognition by arranging all note information in a linear, horizontal format while isolating rhythmic components through separate graphical indicators positioned in proximity to, but visually distinct from, the note representations.

The music notation system comprises a time signature indicator providing time signature information and one or more measure sections aligned with the time signature information. Each measure section includes representations for individual notes to be played arranged in a single horizontal plane to eliminate spatial recognition requirements and avoid navigation across multiple information planes. This single horizontal plane arrangement positions all colored numbers at uniform vertical heights, eliminating the need for musicians to leap across different vertical positions when reading sequential notes, which distinguishes the invention from conventional tablature systems that require spatial processing skills.

Each representation includes one or more colored numbers with the number indicating a fret position of the string instrument and a color representing a string of the string instrument to be played. The colored numbers are spatially arranged in a linear, horizontal format that maintains consistent vertical positioning throughout the musical passage. Additionally, graphical indicators are positioned separately from and in proximity to each colored number indicating a duration each note should be held corresponding to the time signature information. The graphical indicators are visually separated from the colored numbers through distinct spatial gaps, creating clear visual isolation between rhythmic components and note identification information.

This visual separation reduces visual processing complexity compared to conventional notation systems that compact rhythmic, pitch, and fingering information into single note symbols or closely grouped elements. The system may be configured for various string instruments including guitar, bass guitar, or ukulele, and may include features such as color schemes distinguishable by color-blind individuals, digital implementation for electronic devices, and integration with repeat signs and other conventional notation elements. The system may also be used as a scaffolding tool to help students transition to conventional tablature by incrementally expanding the number of information planes.

### BRIEF DESCRIPTION OF THE FIGURES

These and other characteristics of the present invention will be more fully understood by reference to the following detailed description in conjunction with the attached drawings, in which:

FIG. 1 depicts an example music notation system for string instruments under embodiments of the present invention;

FIG. 2 depicts an example of how the notation system works when multiple notes need to be played at the same time in accordance with embodiments of the present invention;

FIG. 3 depicts an example music notation system written for a bass guitar in accordance with embodiments of the present invention;

FIG. 4 depicts an example music notation system written for a guitar in accordance with embodiments of the present invention;

FIG. 5 depicts how the notation system can be customized and used as a scaffolding tool to help students learn how to read conventional tablature by incrementally expanding the number of planes in accordance with embodiments of the present invention;

FIG. 6 depicts another embodiment of the music notation system where the graphical indicator indicating the duration each note should be held corresponding to a time signature indicator providing time signature information is located above the corresponding colored number and using repeat signs in accordance with embodiments of the present invention;

FIG. 7 depicts another embodiment of the music notation system where the graphical indicator indicating the duration each note should be held corresponding to the time signature is located above the corresponding colored numbers and makes use of tails to indicate half notes in accordance with embodiments of the present invention;

FIG. 8 depicts another embodiment of the music notation system where the graphical indicator indicating the duration each note should be held corresponding to the time signature is located above the corresponding colored numbers and makes use of vertical lines to indicate half notes in accordance with embodiments of the present invention;

FIG. 9 depicts a rhythmic exercise featuring how the notation system works in different time signatures including the graphical indicators located above the corresponding colored numbers for half notes, whole notes, and eighth notes in accordance with embodiments of the present invention;

FIG. 10 depicts an example of the color code applied to the open strings of a guitar in accordance with embodiments of the present invention;

FIG. 11 depicts an example of the color code applied to the open strings of a bass guitar in accordance with embodiments of the present invention;

FIG. 12 depicts an example of the color code applied to the open strings of a ukulele in accordance with embodiments of the present invention; and

FIG. 13 depicts a flow diagram 500 for a method for providing notation of music for string instruments in accordance with embodiments of the present invention.

### DETAILED DESCRIPTION

An illustrative embodiment of the present invention relates to a music notation system tailored for string instruments, featuring a time signature indicator providing time signature information, and multiple measure sections aligned with the time signature information of the time signature indicator. Each measure section includes representations for individual notes to be played arranged in a single horizontal plane to eliminate spatial recognition requirements and avoid navigation across multiple information planes. This single horizontal plane arrangement fundamentally differs from conventional tablature systems by positioning all note information at uniform vertical heights, thereby eliminating the need for musicians to visually leap between different vertical positions when reading sequential notes. Each representation showcases colored numbers denoting fret positions on the string instrument and colors symbolizing the strings to be played, wherein the colored numbers are spatially arranged in a linear, horizontal format that maintains consistent vertical positioning throughout the musical passage. Additionally, graphical indicators positioned near the colored numbers specify the duration for which each note should be sustained in accordance with the time signature information. The graphical indicators are visually separated from the colored numbers through distinct spatial gaps, creating clear visual isolation between rhythmic components and note identification information. This separation reduces visual processing complexity compared to conventional notation systems that compact rhythmic, pitch, and fingering information into single note symbols or closely grouped elements. This innovative system provides a user-friendly and visually intuitive method for string instrument players to interpret and perform musical compositions accurately without requiring spatial recognition skills or navigation across multiple information planes.

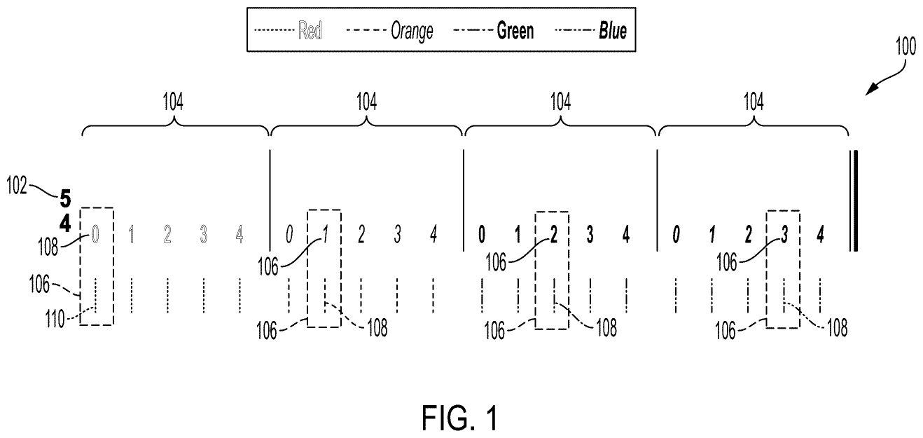

FIG. 1 through FIG. 13 wherein like parts are designated by like reference numerals throughout, illustrate an example embodiment or embodiments of music notation system, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts an example music notation system 100 for string instruments. Here the music notation system includes a time signature indicator 102 providing time signature information, and one or more measure sections 104 aligned with the time signature information of each time signature indicator 102. Each measure section 104 includes one or more representations 106 for each note to be played, wherein the representations 106 are arranged in a single horizontal plane to eliminate spatial recognition requirements and avoid navigation across multiple information planes. This single horizontal plane arrangement positions all colored numbers 108 at consistent vertical heights, eliminating the need for musicians to leap across different vertical positions when reading sequential notes, which is a fundamental problem in conventional tablature systems. Each representation includes one or more colored numbers 108 and a graphical indicator 110 positioned separately from and in proximity to the one or more colored numbers indicating a duration each note should be held corresponding to the time signature information from the time signature indicator 102. The one or more numbers 108 of the representation indicates a fret position of the string instrument while the color of the number 108 represents a string of the string instrument to be played. The colored numbers 108 are spatially arranged in a linear, horizontal format that maintains uniform vertical positioning throughout the musical passage, thereby eliminating spatial recognition requirements that characterize conventional notation systems.

In certain embodiments, the graphical indicator 110 positioned separately from and in proximity to each colored number 108 indicating the duration each note should be held corresponding to the time signature information is located below the corresponding colored number 108. In other embodiments, the graphical indicator 110 is located above the corresponding colored number 108. The visual separation between the graphical indicator 110 and the colored number 108 comprises a distinct spatial gap that isolates rhythmic information from note identification information, thereby reducing visual processing complexity compared to conventional notation systems that compact multiple types of information into single note symbols. In some embodiments, the graphical indicator 110 is colored to match the colored number 108 to be held, while maintaining the visual separation that distinguishes rhythmic components from note identification.

The system 100 is configured for string instruments comprising guitar, bass guitar, or ukulele. Other possible string instruments will be apparent to one skilled in the art given the benefit of this disclosure.

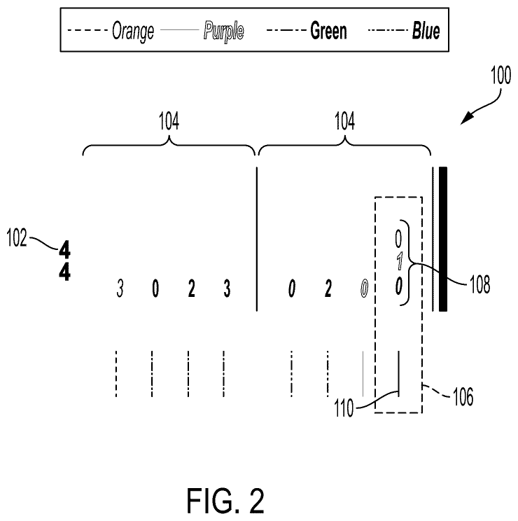

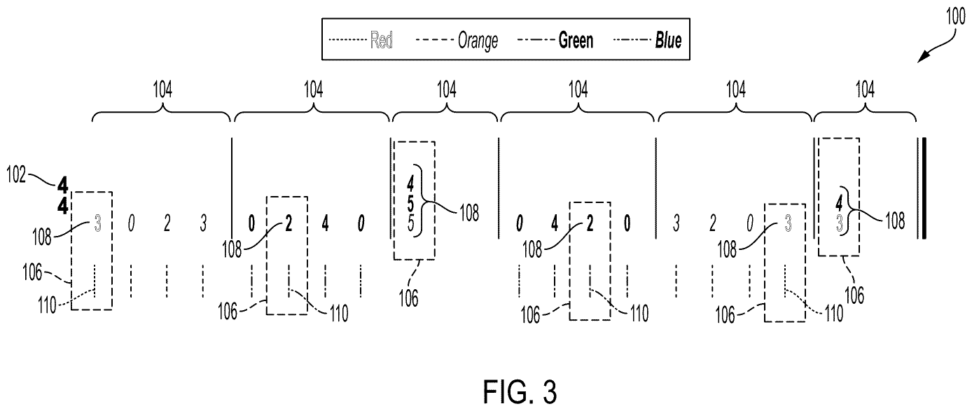

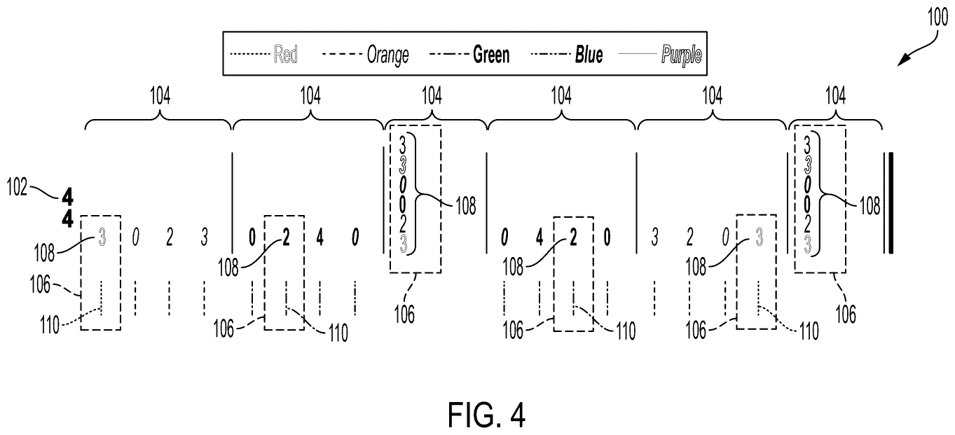

In certain embodiments, the representation 106 for each note comprises multiple colored numbers 108 aligned vertically within the single horizontal plane arrangement. An example of this can be seen in FIGS. 2-4. In FIG. 2 the representation 106 of the last note comprises three colored numbers 108. FIG. 3 and FIG. 4 show how the present music notation system 100 can be used for multiple instruments while maintaining the single horizontal plane arrangement that eliminates spatial recognition requirements. FIG. 3 show a piece written for bass guitar, while FIG. 4 shows the same piece written for a guitar. In these examples, the graphical indicator 110 indicating the duration each note should be held corresponding to the time signature information from the time signature indicator 102 is located below the corresponding colored number 108 with visual separation that isolates rhythmic components from note identification. In FIG. 3 and FIG. 4 the graphical indicator 110 indicating the duration each note should be held corresponding to the time signature information of the time signature indicator 102 is omitted for the note representations 106 having multiple colored numbers 108, demonstrating how the system maintains clarity even when representing chord structures within the single horizontal plane arrangement.

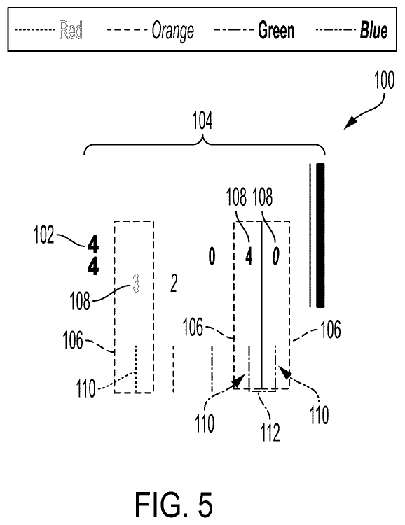

FIG. 5 depicts how the music notation system 100 can be customized and used as a scaffolding tool to help students learn how to read conventional tablature by incrementally expanding the number of planes. Here the numbers 108 of the representations 106 are placed on different levels mirroring the position of the note in the tablature of traditional music notation systems. Like FIGS. 1-4 before it, in FIG. 5 the strumming of a note is indicated by the graphical indicator 110 comprising a vertical line located beneath the colored number 108. However, FIG. 5 also includes a representation 106 where the graphical indicator 110 in proximity to the colored number 108 indicating the duration each note should be held corresponding to the time signature information from the time signature indicator 102 further comprises a line 112 extending horizontally from the vertical line, wherein the line 112 extending horizontally represents the duration the note should be held corresponding to the time signature information of the time signature indicator 102. In this example, the line 112 extending horizontally extends from the bottom of the vertical line and extends to the vertical line of the graphical indicator 110 for the next representation 106 of a note indicating the strumming of a new note.

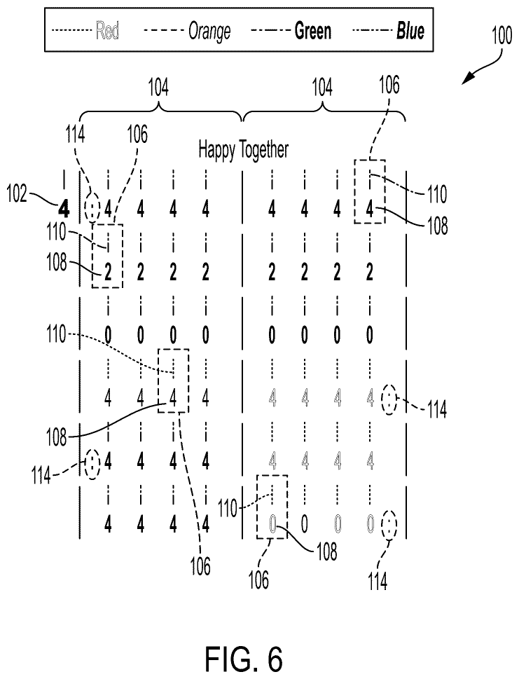

FIG. 6 depicts another embodiment of the music notation system 100 of the present invention where the graphical indicator 110 indicating the duration each note should be held corresponding to the time signature information from the time signature indicator 102 is located above the corresponding colored number 108. In this example, a chart for “Happy Together” by the Turtles is provided showing an alternate format for writing time signature indicators 102 and quarter notes along with the incorporation of repeat signs 114 from conventional staff notation.

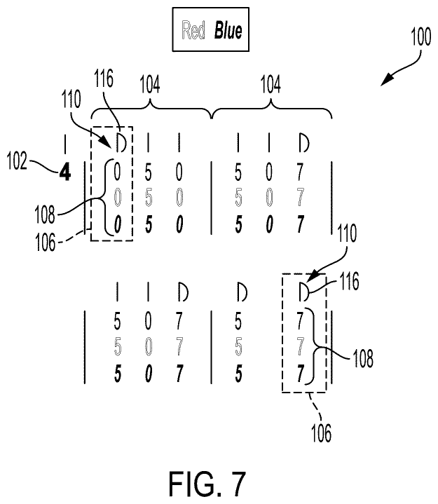

FIG. 7 depicts another embodiment of the music notation system 100 of the present invention where the graphical indicator 110 indicating the duration each note should be held corresponding to the time signature information from the time signature indicator 102 is located above the corresponding colored numbers 108. In the chord progression of this embodiment, half-notes are indicated by the graphical indicator 110 using a tail 116 extending from the top of the vertical line and terminating downward.

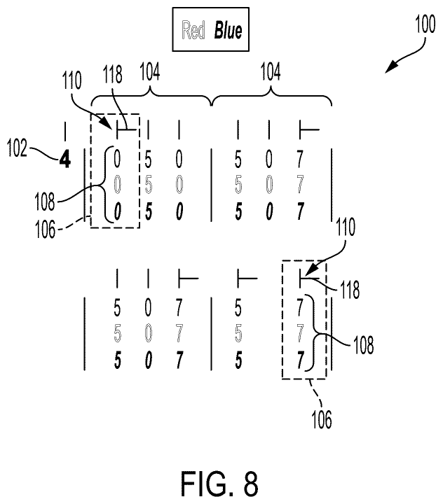

FIG. 8 depicts another embodiment of the music notation system 100 of the present invention where the graphical indicator 110 indicating the duration each note should be held corresponding to the time signature information from the time signature indicator 102 is located above the corresponding colored numbers 108 indicating the chord. In the chord progression of this embodiment, half-notes are indicated by the graphical indicator 110 using a horizontal line 118 extending at a mid-point of the vertical line of the graphical indicator 110.

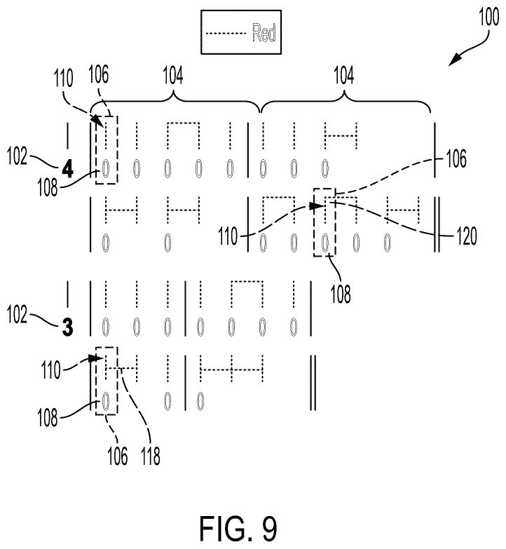

FIG. 9 depicts a rhythmic exercise featuring how the notation system 100 works in different time signature indicators 102 including the graphical indicators 110 located above the corresponding colored numbers 108 for half notes, whole notes, and eighth notes. Here whole notes are indicated by a graphical indicator 110 having a horizontal line 120 extending from the top of the vertical line of the graphical indicator 110 to the vertical line of the graphical indicator 110 of the next representation 106. Half notes are indicated by a graphical indicator 110 having a horizontal line 118 extending from the top of the vertical line of the graphical indicator 110 to the vertical line of the graphical indicator 110 of the next representation 106. Quarter notes are indicated by a graphical indicator 110 comprising a vertical line. Eighth notes are indicated by tying the note stems together with a beam similar to how they are depicted in standard notation.

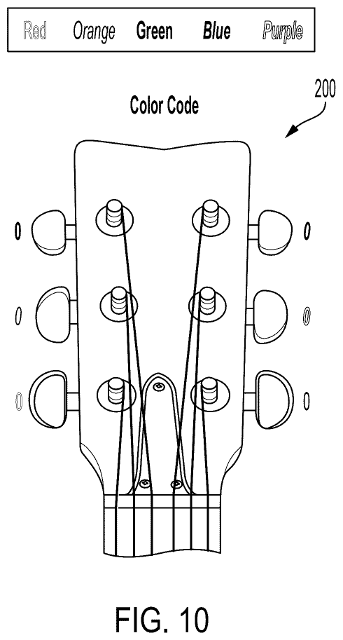

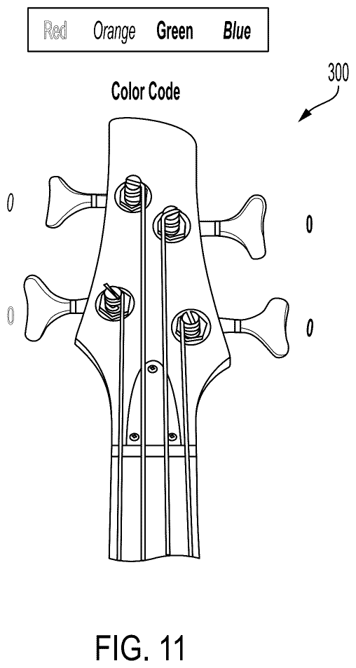

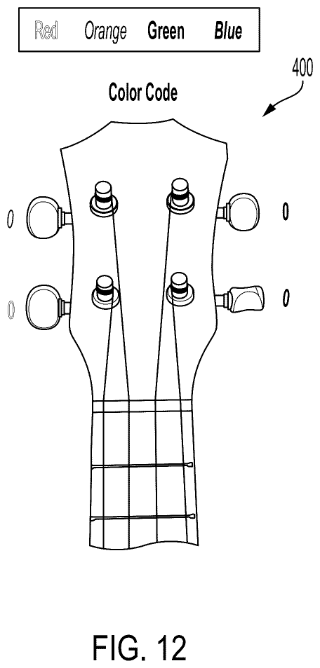

FIGS. 10-12 depict various embodiments of the color code that can be applied to the strings of various string instruments using the system 100 of the present invention. FIG. 10 depicts an example of the color code 200 applied to the open strings of a guitar. FIG. 11 depicts an example of the color code 300 applied to the open strings of a bass guitar. FIG. 12 depicts an example of the color code 400 applied to the open strings of an ukulele. In certain embodiments, the color code of the colored numbers uses colors that are distinguishable by color-blind individuals.

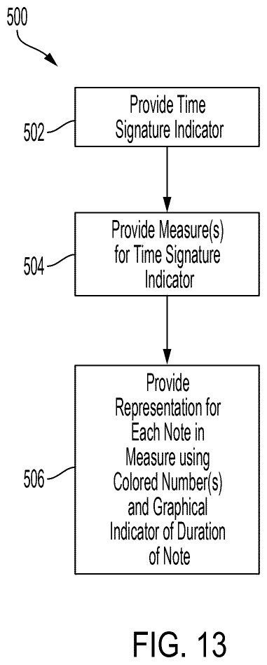

FIG. 13 depicts a flow diagram 500 for a method for providing notation of music for string instruments in accordance with embodiments of the present invention. The method involves providing a time signature indicator 102 for a time signature of the music (Step 502) and providing one or more measure sections 104 for the time signature indicator 102 (Step 504). For each note of the music within the one or more measure sections, a representation 106 is provided (Step 506). The representation includes one or more colored numbers 108 with the number indicating a fret position of the string instrument and a color representing a string of the string instrument producing the note and a graphical indicator 110 in proximity to each colored number 108 indicating a duration each note should be held corresponding to the time signature information of the time signature indicator 102.

The system 100 of the present invention results in notation where the rhythmic component represented by the graphical indicator 110 is visually separated from the note itself indicated by the colored number 108. This visual separation creates distinct spatial gaps that isolate rhythmic information from note identification information, fundamentally reducing visual processing complexity compared to conventional notation systems that compact rhythmic, pitch, and fingering information into single symbols or closely grouped elements. The single horizontal plane arrangement of the colored numbers 108 eliminates the need for musicians to navigate across multiple information planes, as all note information is presented in a linear, horizontal format at uniform vertical heights. This spatial arrangement eliminates the need for musicians to leap across different vertical positions when reading sequential notes, addressing a fundamental limitation of conventional tablature systems that require spatial recognition skills.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may exist in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extent or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way that enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A music notation system for string instruments, comprising:
a time signature indicator providing time signature information; and
one or more measure sections aligned with the time signature information of each time signature indicator, each measure section comprising:
one or more representations for each note to be played arranged in a single horizontal plane to eliminate spatial recognition requirements and avoid navigation across multiple information planes, each representation comprising:
one or more colored numbers with the number indicating a fret position of the string instrument and a color representing a string of the string instrument to be played, wherein the colored numbers are spatially arranged to enable sequential notes to be read at substantially a same vertical position when reading sequential notes; and
a graphical indicator positioned separately from and in proximity to each colored number indicating a duration each note should be held corresponding to the time signature information of the time signature indicator, wherein the graphical indicator is visually separated from the colored number to isolate rhythmic components from note identification, thereby reducing visual processing complexity compared to conventional notation systems that compact multiple types of information into single note symbols.

2. The system of claim 1, wherein the system is configured for string instruments comprising guitar, bass guitar, or ukulele.

3. The system of claim 1, wherein the representation for each note comprises multiple colored numbers aligned vertically.

4. The system of claim 1, wherein the graphical indicator in proximity to each colored number indicating the duration each note should be held corresponding to the time signature information of the time signature indicator is located below the corresponding colored number.

5. The system of claim 1, wherein the graphical indicator in proximity to each colored number indicating the duration each note should be held corresponding to the time signature information of the time signature indicator is located above the corresponding colored number.

6. The system of claim 1, wherein the graphical indicator in proximity to each colored number indicating the duration each should be held corresponding to the time signature information of the time signature indicator is colored to match the colored number to be held.

7. The system of claim 1, wherein the graphical indicator in proximity to each colored number indicating the duration each note should be held corresponding to the time signature information of the time signature indicator comprises a vertical line indicating a strumming of the note.

8. The system of claim 7, wherein the graphical indicator in proximity to each colored number indicating the duration each note should be held corresponding to the time signature information of the time signature indicator further comprises a line extending horizontally from the vertical line, wherein the line extending horizontally represents the duration the note should be held corresponding to the time signature information of the time signature indicator.

9. The system of claim 8, wherein the line extending horizontally from the vertical line extends from a top of the vertical line.

10. The system of claim 8, wherein the line extending horizontally from the vertical line extends from a bottom of the vertical line.

11. The system of claim 8, wherein the line extending horizontally from the vertical line extends from a first vertical line indicating a strumming of a note to a next vertical line indicating a strumming of a new note.

12. The system of claim 8, wherein half notes are indicated by the line extending horizontally at a mid-point of the vertical line.

13. The system of claim 1, further including repeat signs.

14. The system of claim 1, wherein the colors of the colored numbers are distinguishable by color-blind individuals.

15. The system of claim 1, wherein the system results in notation where a rhythmic component represented by the graphical indicator is separated from the note itself indicated by the colored number.

16. The system of claim 1, wherein the single horizontal plane arrangement comprises colored numbers positioned at uniform vertical heights to eliminate vertical spatial navigation requirements.

17. The system of claim 1, wherein the visual separation between the graphical indicator and the colored number comprises a distinct spatial gap that isolates rhythmic information from note identification information.

18. The system of claim 1, wherein the colored numbers use colors that correspond to physical string colors on the string instrument.

19. A method for providing notation of music for string instruments, comprising:
providing a time signature indicator providing time signature information for the music;
providing one or more measure sections aligned with the time signature information of the time signature indicator, wherein each measure section comprises one or more representations for each note to be played arranged in a single horizontal plane to eliminate spatial recognition requirements and avoid navigation across multiple information planes; and
for each note of the music within the one or more measure sections, providing a representation comprising:
one or more colored numbers with the number indicating a fret position of the string instrument and a color representing a string of the string instrument producing the note, wherein the colored numbers are spatially arranged to enable sequential notes to be read at substantially a same vertical position when reading sequential notes; and
a graphical indicator in proximity to each colored number indicating a duration each note should be held corresponding to the time signature information of the time signature indicator, wherein the graphical indicator is visually separated from the colored number to isolate rhythmic components from note identification, thereby reducing visual processing complexity compared to conventional notation systems that compact multiple types of information into single note symbols.
